(19) United States
(12) Patent Application Publication
(10) Pub. No.: US 2014/0012802 A1
(43) Pub. Date: Jan. 9, 2014

(54) WORKFLOW MANAGEMENT SYSTEM FOR COMPUTER NETWORKS

(71) Applicant: systego GmbH, (US)

(72) Inventor: Christian Huber, Buhl (DE)

(73) Assignee: SYSTEGO GMBH, Rheinmunster (DE)

(21) Appl. No.: 13/753,597

(22) Filed: Jan. 30, 2013

Related U.S. Application Data
(60) Provisional application No. 61/593,471, filed on Feb. 1, 2012.

(30) Foreign Application Priority Data
Jan. 30, 2012 (DE) 102012201255.9

(51) Int. Cl. G06F 17/30

(52) U.S. Cl. CPC G06F 17/30011
USPC 707/608

(57) ABSTRACT

A workflow management system for computer networks with a plurality of computers, with client computers connected via a network to a server that provides an IT-infrastructure, having: a first software/hardware device configured to prepare and manage workflows in a programmed fashion to select a sequence of functions necessary to process at least one object in the computer network, if needed parameterize and connect them, with their functional transitions controllable by a computer in the network in order to prepare a workflow from the sequence of functions. The first device preparing the workflow for an access to at least one electronic storage device in which templates are saved, a processor configured to execute workflows based on templates using the first device to process the object, with the workflow executed having access to a database device having actual data of the IT-infrastructure so the executed workflow can be enriched with actual data.

### INCORPORATION BY REFERENCE

The following documents are incorporated herein by reference as if fully set forth: German Patent Application No. 102012201255.9, filed Jan. 30, 2012; and U.S. Provisional Patent Application No. 61/593,471, filed Feb. 1, 2012.

### BACKGROUND

The invention relates to a workflow management system for computer networks with a plurality of computers, namely at least one server computer and a number of client computers, which client computers are connected via a computer network with the server computer, which server computer provides an IT-infrastructure and/or itself is part thereof.

Workflows allow the efficient processing of tasks in computer networks because they standardize and accelerate certain work processes, thus rendering them less error prone. This essentially saves operating time due to a reduced work expense by the system administration. In the past, workflows were frequently prepared manually by specially trained and authorized system users in the form of scripts or the like, which is extremely time consuming and requires appropriately educated users. A further development of this approach includes providing so-called (graphic) workflow editors, which allow the simple coordination of workflows by the drag-and-drop principle on a graphic surface even by less experienced users.

In the following a workflow is understood as any sequence of (program) functions necessary to process at least one object in a computer network. In this context the term “object” shall be understood as quasi unlimited; among other things it comprises the installation of software, for example a device driver, the generation and management of user accounts, the release of a file or a peripheral device, the monitoring of system internal or system external events, for example in a production facility, or the like. In order to prepare a workflow the allocated functions shall be selected, parameterized if applicable, i.e. provided with the appropriate input data and connected in a suitable fashion, with functional transitions between the above-mentioned functions can be controlled by at least one computer in the computer network, with here a workflow developing from the sequence of functions.

In the past, here not only the above-mentioned problem was given, such as the manner to prepare workflows in the computer network and rendering them accessible, but it was particularly considered disadvantageous that existing workflows were embodied relatively static, and any updated configuration of the IT-infrastructure and/or its services/capacities could not be considered.

### SUMMARY

The invention is based on the objective to provide a workflow management system of the type mentioned at the outset, which on the one hand allows to manage the preparation, access, and implementation of workflows in a flexible fashion and which on the other hand creates the option to consider the present status of the IT-infrastructure with regards to its updated configuration and services/capacity when executing workflows.

This objective is attained in a workflow management system with one or more features of the invention. Advantageous further developments of the inventive idea are disclosed below and in the claims, with their wording here explicitly being included in the description by way of reference in order to prevent any repetition of text to the extent possible.

The workflow management system for computer networks according to the invention with a plurality of computers, namely a server computer and a number of client computers, which client computers are connected via a computer network to the server computer, which server computer provides an IT-infrastructure or a part thereof, comprising at least the components described in the following:
a) a first software/hardware device embodied for preparing and managing workflows in a programmed fashion such that a sequence of functions required for processing at least one object in a computer network, is at least one of selected, parameterized, or connected, so that from at least one of said computers functional transitions can be controlled in the computer network in order to prepare a workflow from the sequence of functions, said first software/hardware device for preparing a workflow is adapted to access
b) at least one electronic storage device, in which electronic storage device a number of templates for workflows are saved,
c) a processor adapted and configured in accordance with the first software/hardware device to execute at least one of the workflows based on one of the templates in order to process the object, with the executed workflow having access to
d) at least one database device, said database device comprising actual data of the IT-infrastructure, so that an executed workflow at a time of execution can be enriched with actual data of the IT-infrastructure and thus can be adjusted in its execution to an actual status of the IT-infrastructure.

Therefore, according to the invention the first installation, the electronic storage device, the processor means, and the database device cooperate. The above-mentioned first device serves for preparing and managing of workflows. For this purpose, it accesses the electronic storage device in which storage device a number of templates for workflows are saved. With the help of this installation these templates can be selected, parameterized, and perhaps edited before they are subsequently executed via the processing means. At the time of the execution the performed workflows according to the invention have access to a particular database device, which database device comprises actual data of the IT-infrastructure. Thus, it is possible according to the invention to enrich the performed workflows at the time of execution with actual data of the IT-infrastructure. This means that the above-mentioned actual data is considered for the execution of the workflow and its processing can therefore be influenced appropriately. This also means that the workflow can be adjusted and/or is adjusted in its execution to the actual status of the IT-infrastructure.

For example, in the database device the IT-infrastructure is saved as the actual status such that it provides two servers in a certain computing center to offer a web service, while at an appropriate utilization of the web service a third server can be added to another computing center. This additional switching shall here occur when the utilization of the first two servers exceeds a certain threshold. In the execution of a respective workflow it is therefore provided within the scope of the present invention that both the present configuration of the IT-infrastructure as well as the actual load or utilization is considered based on the above-mentioned actual data and that the workflow can occur accordingly adjusted based on the above-mentioned actual data in order to add for example the above-mentioned third server as soon as the actual utilization of the first two servers exceeds the above-mentioned threshold.

As discernible by one trained in the art the present invention is not limited to the above-described exemplary embodiment at all, rather it can be expanded to any possible applications within computer networks in which a workflow is executed which accesses the actual data of the IT-infrastructure at the time of execution and considers it in its process.

A first further development of the system according to the invention provides that the above-described database device comprises at least two databases. One of these databases can be called a static database, while the other database represents a dynamic database. Here, the first-mentioned static database includes data regarding an actual status of the real and/or virtual configuration of the IT-infrastructure, which comprises technical resources installed in the form of software or hardware. The second-mentioned dynamic database includes data regarding an actual status of the real and/or virtual service/capacity or load of the IT-infrastructure. The latter aspect is alternatively called “performance” and comprises for example the utilization of resources of the IT-infrastructure in the form of existing server connections, data throughput, CPU-capacity, or the like. This way when executing the workflows different actual values or actual data of the IT-infrastructure can be flexibly accessed, which is relevant for different time schedules. The first database represents a time schedule in the range of days, weeks, or months, while the time schedule of the second database rather relates to a range of seconds or minutes.

Another further development of the system according to the invention provides that the templates for workflows saved in the electronic storage device comprise at least one of the following and preferably all of the following types of patters, without restrictions thereto, though:
editing templates essentially subject to free editing by the user, particularly a user of a first device;
VDI templates for workflows to provide virtual computer units, preferably for virtualizing desktop PCs, workstation computers, or microcomputers, most preferred for providing training environments;
workplace management templates for standard workflows within the scope of the system administration, such as the release of peripheral devices, the changing of passwords, the implementation and management of user accounts, or the like.

The editing templates represent a so-called “custom workflows”, which allow an appropriately trained and authorized user to generate essentially unrestricted and completely new workflows. The VDI-templates particularly allow the provision of virtual desktops, for example to generate a training environment with a number of virtual PCs and a trainer PC at a certain location and a certain point of time. VDI-templates include respectively predetermined workflows, which particularly need to be adjusted only to the above-mentioned parameters, which is also easily possible for a less experience user with respective authorization. Furthermore, so-called workplace administration templates are provided, which include standard workflows within the scope of the system administration, which today frequently are still prepared in a time-consuming manual process by system administrators. This relates for example to the release of peripheral devices, such as printers or the like, the changing of passwords, the establishment of user accounts, or the like.

Within the scope of a respective further development of the system according to the invention it has proven particularly advantageous if the above-mentioned templates are saved in a read-only format in the storage device, so that they cannot be deleted by inexperienced users and thus remain lastingly available within the system.

Another further development of the system according to the invention provides that the selection of the saved templates, i.e. the selection which types and sorts of templates are saved in the storage device, occurs based on a statistic prepared and managed by the system provider. Such a statistic may be oriented particularly on the frequency of certain user requests by the users of the system of said present provider and thus particularly being equivalent to a FAQ-hit list (FAQ=frequently asked questions). The provider or operator of the system is capable at all times, of course, to change, amend, or update the saved templates based on new consulting questions or for other reasons.

Another further development of the system according to the invention provides that the first installation comprises at least one of the following components, preferably embodied by software:
a workflow drafting device which is communicatively connected to an electronic inventory list of the IT-infrastructure on the one side and to the storage device on the other side, which workflow drafting device preferably provides a user interface by which user interface a user can access the workflow templates, most preferably at least the editing templates in order to prepare new and/or adjusted workflow templates and save them in the storage device;
a workflow management device embodied for the purpose to implement existing workflows depending on predetermined or potentially predetermined workflow function parameters as well as preferably after release by an authorized user, to be executed via the processor means;
a process automation database preferably communicatively connected to the workflow drafting device and/or to the workflow management device and which includes process automation data connected to the preparation, management, and execution, particularly the workflow function parameters and/or log-data for installed and/or amended workflows

The option for drafting and managing/processing workflows by users of the system has already been pointed out in general. Within the scope of the further development of the system according to the invention the workflow drafting device according to the system serves to prepare new workflow templates or to process existing workflow templates. These workflow templates can then be saved again in the storage device. Here, for this purpose the workflow management device is provided to select existing workflows, parameterize them for a given application, and subsequently execute them. This may generally be initiated even by less experienced users, which is discussed in greater detail in the following. However, the workflow management device may also include a releasing option particularly for new or amended workflows by an authorized user. The above-mentioned process automation database may particularly serve the purpose to record the history of amendments for workflows.

It has already been pointed out that at least the workflow drafting device should not easily be accessible for a less experienced end user of the system.

A most preferred further development of the system according to the invention provides for a communication device for a bi-directional communication in a web portal in order to save new or amended workflow templates for the use by other users of the system or to download respective templates therefrom. Thus, if a system user or an employee of the system provider prepares a new workflow, according to a further development of the system, there is the option to save this workflow on the web portal, in order to render it available for other users. Inversely, a user of the system can check the above-mentioned web portals, if here workflows are already available which can or might be used for addressing a certain problem.

Another further development of the system according to the invention is characterized in a first access device by way of software/hardware, which accessing device is embodied to provide a user with a communicative access to the first device. Here the user may particularly represent an end user or an administrator, with in the present case the term “end user” representing a less experienced user and the term “administrator” a well-trained and appropriately authorized experienced user. The above-mentioned communicative access can extend particularly to the workflow drafting device and/or the workflow management device, which appropriately allows the respective user to prepare, edit, and manage workflows or to execute them. Here, the above-mentioned first accessing device may comprise preferably an internet browser. However it is not mandatory for the access to occur via the internet, alternatively the access may also occur via an intranet, extranet, or via any other communication network of data technology, such as a mobile radio network or the like.

The above-mentioned access devices must be distinguished from a second access device of software/hardware technology according to the invention provided, based on another further development of the system, which in turn is embodied to provide a second software/hardware device with communicative access for the first device. The second device mentioned may particularly represent a real-time event management or an IT-service management. They symbolically represent automated processes or software applications, which access the first device without any direct activity of a user. Preferably the respective access is possible by the second device to a limited extent only. For example, the second device generally has no authorization to prepare workflows or to process them, but merely allows the administration thereof in the sense of selecting or executing.

For example, it may be possible in a real-time management application to start a suitable workflow via the second access device, by which the system reacts to the underlying event. The same approach can be used within the scope of an IT-service management to ensure the IT-service quality.

If in this case it is mentioned that the access occurs to the first device of the system via a web service, here a web service represents a software application which can be clearly identified, described, or can be found with a uniform resource identifier (URI) and its interface as a XML-artifact, or in any similar fashion. This way a web service supports the direct interaction with other software agents using XML-based messages or the like by exchanging via internet-based protocols.

A most preferred further development of the system according to the invention is characterized in the possibility to access the database device, preferably the first static database of the database device. This way it is possible via the described access option to model the actual status of the real and/or virtual configuration of the IT-infrastructure. Such an option for modeling has already been mentioned above as an example. Due to the fact that the workflows can access the database device to execute the workflows at a certain point of time such a modeling of the IT-infrastructure directly includes the workflows and/or they are considered in the execution.

Within the scope of another further development of the system according to the invention it may additionally be provided that the IT-infrastructure comprises technical hardware and software IT-installations of different manufacturers and/or service providers. The present invention allows this way for the first time to model the IT-infrastructure independent from the manufacturer for the purpose of considering actual data for executing workflows.

### BRIEF DESCRIPTION OF THE DRAWINGS

In the following, additional features and advantages of the present invention are explained based on exemplary embodiments with reference to the drawing.

FIG. 1 shows schematically an embodiment of the workflow management system according to the invention.

### DETAILED DESCRIPTION OF THE PREFERRED EMBODIMENTS

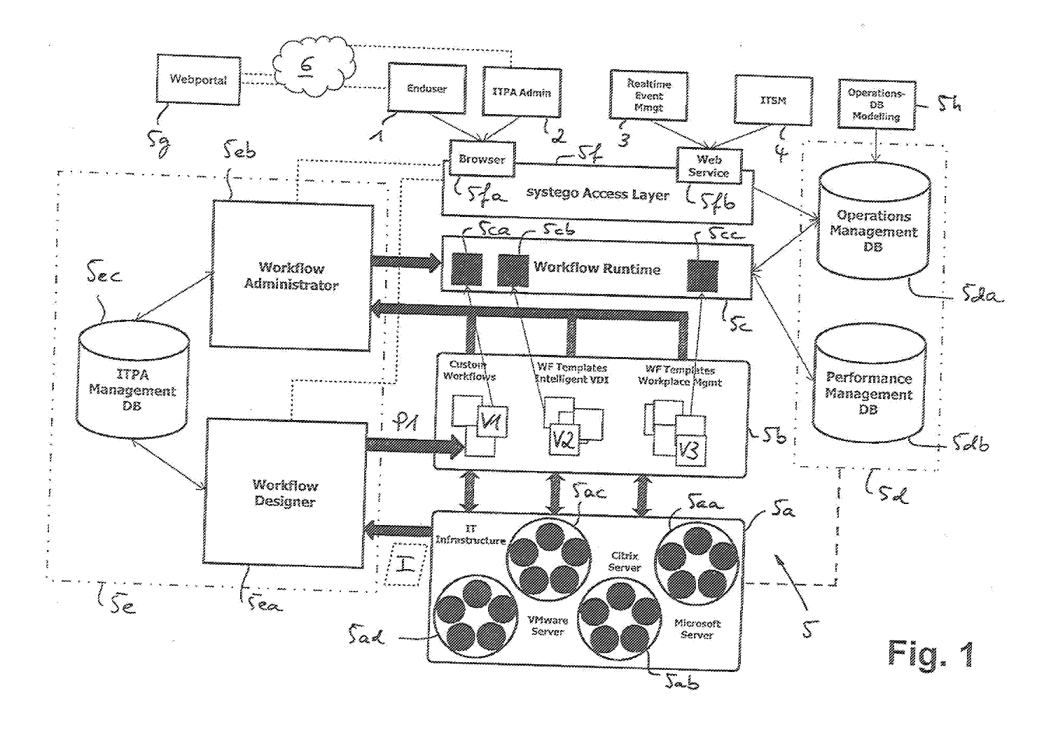

Based on a block diagram FIG. 1 shows schematically a workflow management system for computer networks with a plurality of computers. Here, the term computer shall be interpreted comprehensively and comprise not only conventional workstation computers (desktop PCs) but also servers, notebooks, and all types of programmable and digital devices controlled by software, such as smartphones, multimedia-devices, game consoles, televisions, and the like, which can communicate with each other via a computer network.

In accordance with FIG. 1 the workflow management system (in the following called “system” for short) initially comprises first to fourth computers (reference characters 1-4) also called client computers. Computer 1 is marked “end user”, which means that it is allocated to an end user of the system. Here, an end user is considered a user only applying the system in an (access-restricted) form without being equipped with extensive administrator authorization.

Computer 2 is marked “ITPA Admin” and accordingly it is allocated to an administrator for IT-process automation. Accordingly this user represents a user with comprehensive access authorization for the design and operation of the system.

Computer 3 is marked “Real Event Management (Mngt)”. It represents a device embodied and installed for a (fully automated) event monitoring, for example a sensor in a production facility, a card reader for building access control, or the like.

Computer 4 is marked “ITMS”, representing the term “IT-service management”. This may represent an end device which is appropriately equipped (by way of software) to monitor the quality of a certain IT-service, such as the availability of a program or the duration of a connection via the internet.

The above-described computers 1-4 according to the arrows originating there access a server computer 5 via a not explicitly displayed computer network, with its essential components being explained in greater detail in the following:

The server computer 5 provides an IT-infrastructure in a computer network, which is marked with the reference character 5a in FIG. 1. According to the present illustration such an IT-infrastructure 5a comprises for example a first server 5aa (Microsoft server, i.e. server for applications of the company Microsoft), a second servicer 5ab (Citrix server, i.e. server for applications of the company Citrix), a third server 5ac (VMware-server, i.e. server for applications of the company VMware), and a fourth server 5ad not described in greater detail, without the invention being restricted to such a number or selection of servers 5aa-5ad. As discernible by one trained in the art the servers 5aa-5ad are not mandatorily embodied as (sub) components of the server computer 5, but may at least partially be realized as independent physical entities

Further, the server computer 5 comprises at least one electronic storage device 5b, in which storage device 5b a number of templates for workflows are saved. In FIG. 1, the above-mentioned templates are not explicitly marked in their total number for reasons of visibility. As an example, the reference character V1 marks a template for a so-called “custom workflow”, i.e. a workflow which can essentially be freely edited to prepare a new workflow within the system. The reference character V2 shows as an example a template for a workflow to provide virtual computers, which is marked in FIG. 1 also as “WF template intelligent VDI”. The reference character V3 is an example for a template of workspace administration for standard workflows within the scope of system administration, which in FIG. 1 is also marked “WF template workplace management (Mgmt)”.

In general, workflow relates to a sequence of (program) functions required to process at least one object in a computer network. The above-mentioned object may represent any arbitrary object that can be processed in a computer network, for example without limitations thereto a user account, a storage space administration, a file or printer release, a device driver, or the like. Accordingly such workflow includes a sequence of functions or commands, which are appropriately parameterized or connected depending on the application, with the functional transitions from at least one computer into a computer network can be controlled such that a workflow develops from the sequence of functions.

The templates V1-V3 illustrate certain templates of typical workflows for certain objects, which at the most require parameterization and subsequent execution and/or processing. Here, the types of templates V2 and V3 are subject to particular types of processes, which have already been pointed out above. For example the templates of the type V2 serve for providing computers, preferably for the virtualization of desktop PCs, workplace computers, or microcomputers, most preferably for generating training environments, when for example at a certain date six virtual training PCs and one trainer PC is required with the appropriate software. Here, the templates of the type V3 represent standard work processes within the scope of system administration. This includes for example the release of peripheral devices (printers, scanners, or the like), the changing of passwords, the installation and management of user accounts or the like. Both types of workflows V2 and V3 require only little user input for their process and otherwise proceed on the given IT-infrastructure 5a essentially always according to the same template.

The editing templates of the type V1 however allow an experienced use an essentially unrestricted generation of a new workflow, which is discussed in greater detail in the following.

Furthermore, at the reference character 5c the system 5 comprises processing means, which are embodied and implemented to execute at least one of the workflows based on the templates V1-V3. In FIG. 1 this is also marked as “workflow runtime”. The black squares within the box 5c also mark so-called workflow instances (“instantiated workflows”), which are marked with the reference characters 5ca-5cc in FIG. 1. Here, it is essential that the executed workflows 5ca-5cc have access to a database device 5d, which database device 5d comprises actual data of the IT-infrastructure 5a. The accessibility is indicated in FIG. 1 by the connecting arrows between the processor means 5c and the database device 5d and/or the databases 5da, 5db included in the database device 5d. Here the database 5da represents a statically marked database, which includes data regarding an actual status of the real and/or virtual configuration of the IT-infrastructure 5a. This database is also marked “operations management DB” in FIG. 1. The other database 5db represents a database which includes data regarding an actual status of the real and/or virtual capacity under load of the IT-infrastructure 5a.

For example, it is listed in the operation database 5da if a web service offered by the system 5, which is discussed as an example in the following, presently uses the resources of a certain number of servers in a certain computer center, which number shall be increased when a load threshold is reached. The performance database 5db includes data regarding the actual (measured) performance or load of the IT-infrastructure 5a, for example it's CPU-capacity, a number of certain server connections, data throughput and transmission rate, or the like. By the access of the processor means 5a on the database device 5d and/or the databases 5da, 5db included therein, within the scope of the present invention there is the option to enrich a workflow 5ca-5cc at the time of execution with actual data of the IT-infrastructure 5a and this way to adjust its execution to an actual status of the IT-infrastructure 5a.

In this context, the term “enriching” means that a precise sequence of the workflow depends on the actual data included in the database device 5d, i.e. the actual data is considered when executing the workflow, here in the form of parameters, in order to adjust the process of the workflow to the actual status of the IT-infrastructure. In this context the dot-dash line at the right bottom of FIG. 1 marks an effective software and communicative connection between the IT-infrastructure 5a and the database device 5d, hereby ensuring that the database device 5d always includes actual data regarding the IT-infrastructure 5a.

Furthermore, the system 5 comprises at the reference character 5e (dot-dash lined box in the left part of FIG. 1) a software/hardware device, which is embodied to prepare and manage workflows. For this purpose, the device 5e has access to the storage device 5b and/or the templates V1-V3 included therein, which in FIG. 1 is symbolized in a respective arrow P1. As discernible for one trained in the art, the above-mentioned arrow P1 only points to the editing template V1, in which generally only a real processing of workflows occurs by the user. The arrow P1 starts at a workflow draft device 5ea, marked as “workflow designer”, which preferably provides a user interface by which user interface a user can access the workflow templates V1, in order to prepare new and/or adjusted workflow templates and save them in the storage device 5b. The use of the workflow draft device Sea is preferably only accessible by trained users with respective authorization. All other users shall generally apply the already prepared workflows V2 and V3.

With the reference character I schematically an electronic inventory list of the IT-infrastructure is also shown, which the workflow draft device 5ea and/or the user applying it can access in order to prepare workflows, which show a certain reference to the IT-infrastructure 5a. Accordingly the vertical double arrows between the IT infrastructure 5a and the storage device 5b in FIG. 1 symbolize that the workflow templates saved in the storage device 5b show a certain connection to the real/virtual conditions of the IT-infrastructure 5a.

In addition to the already described workflow draft device Sea the device 5e comprises at the reference character 5eb also a workflow management device. It is embodied to execute existing workflows (template V1-V3) in the storage device 5b depending on the predetermined or predeterminable functional workflow parameters via the processor means 5c, which has already been pointed out. This may include that via the workflow management design 5eb first a release of the workflows must occur by an authorized user, for example a system administrator, before the workflows can be executed in the system. Additionally, via the workflow management device certain types of workflows can be generally released for certain user groups within the system, while other user groups have no access to certain workflows, here.

According to FIG. 1 the device 5e further comprises a process automation database 5ec, which in FIG. 1 is also marked “ITPA management DB”. The above-mentioned database 5ec is in a communicative connection both to the workflow draft device 5ea as well as the workflow management device 5eb. It includes process automation data, which is related to the preparation, management, and execution of workflows. In particular, here workflow parameters and/or log-data for existing and/or amended workflows can be saved, for example in order to allow a comprehending amendment history.

Furthermore, the system 5 according to FIG. 1 also includes a first access device 5fa, which is embodied to provide a user, particularly an end user (computer 1) or a process automation administrator (computer 2), with communicative access to the device 5e, namely at least to the workflow management device 5eb or the workflow management device 5eb and the workflow draft device 5ea (the latter only in case of the administrator; computer 2). In FIG. 1 the latter access device is particularly embodied as a web browser, while the above-mentioned access options are symbolized by dot-dash connection lines. The web browser 5fa is a component of a superordinate device 5f, which in FIG. 1a is also marked “systego access layer”. As already mentioned, the access device 5a allows the end user 1 to access only the workflow management device 5eb, for example by entering a password or by single-sign on so that the end user 1 can execute a certain (previously saved) workflow, but cannot change it or generate a new workflow. However, via the access device 5fa the administrator 2 can also access the workflow draft device 5ea, in order to newly generate or process workflows, subsequently save them, and/or execute them.

The above-mentioned superordinate device 5f also comprises a second access device 5fb, which is embodied to provide another software/hardware device with access to the device 5e. According to FIG. 1 the above-mentioned software/hardware device represents a computer or end user device 3, 4 as already discussed, in the present case also a real-time event management and an IT-service management, which has already been discussed in detail. Such software/hardware devices 3, 4 preferably access only the workflow management device 5eb, in order to execute predetermined workflows, for example when a certain event occurs and/or when an IT-service quality fails to meet certain requirements. As shown in FIG. 1, the second access device 5fb is embodied as a web service. The web service represents a software application which can clearly be identified with a uniform resource identifier (URI) and which its interface can be defined, described, and found via an XML-artifact. A web service supports the direct interaction with other software agents, for example on the devices 3, 4 and the use of particular XML-based messages, for example by the exchange via internet base protocols, per se known to one trained in the art. Via the web service Mb it is therefore possible within the above-described system 5 to automatically apply workflows, which are “enriched” with updated data of the IT-infrastructure 5a of the system 5.

As further shown in FIG. 1, the system 5 further comprises a web portal 5g, which not necessarily requires a physical implementation on the same infrastructure as the remaining system 5. The end user 1 and the administrator 2 are capable to access the web portal 5g via a computer network, in the present case the internet 6, with a suitable communication device being provided for a bidirectional communication between the user and/or the devices 1, 2 and the web portal 5g, for example like an internet browser, known to one trained in the art and not explicitly shown in FIG. 1. The web portal 5g serves to save new or amended workflow templates for the use by other users of the system or to download respective templates therefrom. Thus, when for example a new workflow template has been prepared for a workflow frequently required in the system 5 based on an editing template V1, this template may be saved by an appropriately authorized user, for example the administrator 2, via the internet 6 in the web portal 5g for general application.

Finally, at the reference character 5h an optional access to the database device 5d is shown, preferably the operation database 5da within the database device 5d. The above-mentioned access option 5h could be provided as a software interface or a user interface within the system 5. However it is also possible to access via a computer network and/or a respective data connection to the database 5da, if for this purpose a respective authorization is given. The access option 5h allows to model the actual status of the real or virtual configuration of the IT-infrastructure, as saved in the respective database 5da. In other words, an appropriately authorized user is provided with the option to adjust the configuration of the IT-infrastructure to certain requirements in a targeted fashion. For example, in this context it has already been mentioned, that a certain implementation of the web service 5fb can be adjusted or modeled such that for this purpose generally always two servers are provided, however upon reaching a certain (load) threshold in a certain computing center a third service shall be provided for the web service 5fb. This general provision is included in the operation database 5da, while the above-mentioned threshold inquiry occurs based on the content of the performance database 5db, which has already been pointed out In particular it is possible for operating the workflow management device 5eb to provide the end user (computer 1) and the administrators (computer 2) with various operating interfaces, which appropriately limit and/or expand the access options of the user.

Overall, the present invention allows a comprehensive generation and management of workflows in computer networks, which workflows are characterized in a novel manner in an operation with actual data of the IT-infrastructure and in this context allow a wide range of adjustments of infrastructure data.

1. A workflow management system for computer networks with a plurality of computers, including at least one server computer (5) and a number of client computers (1-4), said client computers being connected via a computer network to the server computer, said server computer providing an IT-infrastructure (5a), comprising:
a) a first software/hardware device (5e) embodied for preparing and managing workflows in a programmed fashion such that a sequence of functions required for processing at least one object in a computer network, is at least one of selected, parameterized, or connected, so that from at least one of said computers functional transitions can be controlled in the computer network in order to prepare a workflow from the sequence of functions, said first software/hardware device for preparing a workflow is adapted to access
b) at least one electronic storage device (5b), in said electronic storage device a number of templates (V1-V3) for workflows are saved,
c) a processor (5c) which is adapted and configured in accordance with the first software/hardware device (5e) to execute at least one of the workflows based on one of the templates (V1-V3) in order to process the object, with the executed workflow having access to
d) at least one database device (5d), said database device comprising actual data of the IT-infrastructure (5a), so that an executed workflow at a time of execution can be enriched with actual data of the IT-infrastructure and thus can be adjusted in its execution to an actual status of the IT-infrastructure.

2. A system according to claim 1, wherein the database device (5d) comprises at least two databases, including: a first static database (5da) and a second dynamic database (5db), said first static database includes first data regarding an actual status of at least one of real or virtual configurations of the IT-infrastructure (5a), and said second dynamic database includes second data regarding an actual status of at least one of real or virtual performance or a load of the IT-infrastructure (5a).

3. A system according to claim 1, wherein the templates (V1-V3) for the workflows comprise at least one of the following types of templates:
freely editable templates (V1) that can essentially be freely edited by a user;
VDI-templates (V2) for workflows to provide virtual computer units for virtualizing at least one of desktop PCs, workspace computers, or microcomputers, or to create training environments;
workspace management templates (V3) for standard workflows within a scope of system management.

4. A system according to claim 3, wherein the templates (V1-V3) are saved in a read-only format in the storage device (5b).

5. A system according to claim 4, wherein a selection of the saved templates (V1-V3) occurs based on a statistics prepared and managed by a system provider, which statistics consider frequency of inquiries for consulting by users of the system.

6. A system according to claim 1, wherein the first software/hardware device (5e) comprises at least one of the following components:
a workflow draft device (5ea) communicatively connected by a data transfer arrangement to an electronic inventory list (I) of the IT-infrastructure (5a) on one side and to the storage device (5b) on the other side, said workflow draft device providing a user interface by which a user can access the workflow templates, in order to generate at least one of new or modified workflow templates and to save them in the storage device (5b);
a workflow management device (5eb) configured to execute existing ones of the workflows depending on predetermined or predeterminable workflow function parameters via the processor (5c);
a process automation database (5ec) which is communicatively connected to at least one of the workflow draft device (5ea) or the workflow management device (5ea), and which comprises process automation data connected to the preparation, management, and execution of at least one of the workflow function parameters or log data for established or amended workflows.

7. A system according to claim 6, wherein at least one of the workflow draft device (5ea) or the workflow management device (5ea) are not openly accessible for an end user (1).

8. A system according to claim 6, further comprising a communication device for a bidirectional communication with a web portal (5g) in order to save new or amended workflow templates in said web portal for use by other users or to download respective templates therefrom.

9. A system according to claim 8, further comprising the web portal (5g).

10. A system according to claim 6, further comprising a first software/hardware access device (5fa) configured to provide a user with data access to the first device (5e), including at least one of the workflow draft device (5ea) or the workflow management device (5eb), in order to prepare, process, manage, or execute the workflows.

11. A system according to claim 10, further comprising a second software/hardware access device (5fb) configured to provide a second software/hardware device data access to the first device (5e) in order to prepare, process, manage, or execute workflows, with the second access device (5fb) being configured to provide access via a web service.

12. A system according to claim 2, further comprising an access option to the database device (5d) in order to model the actual status of at least one of the real or virtual configuration of the IT-infrastructure (5a).

13. A system according to claim 1, wherein the IT-infrastructure (5a) comprises hardware and software IT-devices (5aa-5ad) of at least one of different manufacturers, suppliers, or service providers.

14. A system according to claim 13, wherein a configuration of the IT-infrastructure (5a) is modelable independent from a manufacturer.

15. A system according to claim 3, wherein the standard workflows within the scope of system management includes release of periphery devices, change of passwords, establishment and management of user accounts.

16. A system according to claim 6, wherein the user interface allows a user to access at least the editing templates (V1).

17. A system according to claim 10, wherein the first software/hardware access device (5fa) comprises an internet browser.
